(19) United States
(12) Patent Application Publication
(10) Pub. No.: US 2015/0365875 A1
(43) Pub. Date: Dec. 17, 2015

(54) Selecting a Radio Access Network Cell

(71) Applicant: TELEFONAKTIEBOLAGET L M ERICSSON (PUBL), Stockholm (SE)

(72) Inventors: Per-Daniel STALNACKE, Bromma (SE); Tomas NYLANDER, Varmdo (SE); Jari Tapio VIKBERG, Jarma (SE)

(73) Assignee: Telefonaktiebolaget L M Ericsson (publ), Stockholm (SE)

(21) Appl. No.: 14/767,965

(22) PCT Filed: Mar. 1, 2013
(86) PCT No.: PCT/EP2013/054191

§ 371 Date: Aug. 14, 2015

(51) Int. Cl. H04W 36/36; H04W 36/10; H04W 36/08

(52) U.S. Cl. CPC H04W 36/36; H04W 36/08; H04W 36/10; H04W 84/12

(57) ABSTRACT

A method and apparatus for selecting a radio access network cell for connecting to a communications network. A client device that is connected to a Wi-Fi access network cell sends a request message to a node in the Wi-Fi access network cell. It receives a response from the node that includes information identifying at least one overlapping radio access network cell and a property of the overlapping radio access network cell. On the basis of a comparison between the property of the radio access network cell and a corresponding property of the Wi-Fi access network cell, the node determines whether to remain connected to the Wi-Fi access network cell or to move to the radio access network cell. This has the advantage that a client device that is already associated with a Wi-Fi AP can determine if another access network cell could provide it with a better service, for example if the conditions of the AP change dynamically.

### TECHNICAL FIELD

The invention relates to the field of selecting a radio access network cell for a client device to connect to

### BACKGROUND

There is currently a drive to use Wi-Fi access networks to off-load the 3GPP network. As illustrated in FIG. 1, node such as a Radio Base Station (RBS) 1 provides 3GPP services within a certain area A. Within that area A, one of more Wi-Fi ‘hotspots’ may be provided by Wi-Fi Access Points (APs) 2, each of which allows Wi-Fi access to a communications network for a mobile client device 3 such as a User Equipment (UE). A UE 3 therefore can choose to access a communications network via 3GPP, Wi-Fi or both.

UEs 3 that are both 3GPP capable and Wi-Fi capable can use either type of access. If a UE 3 is capable of accessing a Wi-Fi Access Point, and such accessing is enabled, the UE 3 will typically automatically connect to a (known) Wi-Fi network as soon as the UE 3 detects the Wi-Fi network. The UE 3 will maintain its 3GPP registration for services such as voice and short message service (SMS), but will normally use the Wi-Fi access network for packet data.

The decision for the UE 3 to move from the 3GPP Radio Access Technology (RAT) to the Wi-Fi access network is taken by the UE without any knowledge about the situation in the 3GPP access network or the Wi-Fi access network. This can lead to a potentially worse performance and an overload at the Wi-Fi access network even when the 3GPP access network has spare capacity.

Neither the 3GPP access network nor the Wi-Fi access network has any knowledge about the other. When the UE 3 connects to the Wi-Fi access network, it appears to the 3GPP access network that the UE 3 is simply disconnecting from the packet switched (PS) services in the 3GPP access network just like any other disconnection, while in fact it has moved to the Wi-Fi access network.

Before a UE 3 associates to a Wi-Fi AP 2, at least partly using 802.11u and the HotSpot 2.0 specifications, it is possible for the UE 3 to query the Wi-Fi AP 2 about, among other things, any 3GPP Public Land Mobile Networks (PLMN) that can be accessed via the AP 2. The protocol used is called Access Network Query Protocol (ANQP) and the ANQP query is performed before the UE is associated with the Wi-Fi AP as is shown in FIG. 2. FIG. 2 also shows exemplary communication with an Authentication, Authorization and Accounting (AAA) Server 4, and a Dynamic Host Configuration Protocol (DHCP) Server 5.

Information about other 3GPP PLMNs is configured in the Wi-Fi AP 2 (or in a Wi-Fi Access Controller, AC, depending on the CAPWAP architecture between the AP and the AC). The Wi-Fi AC may also be known as a Wi-Fi Controller (WIC). The UE 3 can use the received information to decide if it should select an AP 2, and continue to connect and authenticate to a certain Core Network.

802.11u and Hotspot 2.0 can also be used for the UE 3 to request Wireless Access Network (WAN) metrics information from the AP 2 using an ANQP query, which can then provide the load and capacity of the WAN. In addition, the Beacon frame that is broadcasted from the Wi-Fi AP 2 contains a BSS Load information element containing information about the air interface load in the Wi-Fi AP 2.

When associated to Wi-Fi, the UE can by using the 802.11k specification ask the AP in a “Neighbour report request” for the identity of nearby APs in the same network. Then the UE 3 may try to listen of the broadcast messages of those nearby APs to detect load information contained in the Beacon frame or actively use ANQP towards the nearby APs. Based on that, the UE 3 might decide to move to one of the nearby APs (for example, if it could receive a better signal strength, or if the nearby AP is experiencing less congestion), but this is up to the UE 3 to decide.

When associated to a Wi-Fi AP, the UE 3 can obtain information about the conditions of in nearby Wi-Fi APs, but it cannot obtain similar information from other overlapping radio access network cells, such as 3GPP cells. These may provide a better alternative for the UE.

Furthermore, the existing methods for obtaining conditions of other nearby Wi-Fi APs is based on the UE 3 trying to listen to the broadcasted Beacon frames from those nearby Wi-Fi APs, or the UE 3 actively performing an ANQP query to a nearby APs.

### SUMMARY

It is an object to provide a mechanism by which a mobile client device such as a UE, which is already associated with a Wi-Fi access network cell, can determine whether to remain associated with the existing Wi-Fi access network cell or move to a different radio access network cell (which may be, for example, a 3GPP cell or an alternative Wi-Fi access network cell), depending on which radio access network cell would better serve the mobile client device.

According to a first aspect, there is provided a method of selecting a radio access network cell for connecting to a communications network. A client device that is connected to a Wi-Fi access network cell sends a request message to a node in the Wi-Fi access network cell. It receives a response from the node that includes information identifying at least one overlapping radio access network cell and a property of the overlapping radio access network cell. On the basis of a comparison between the property of the radio access network cell and a corresponding property of the Wi-Fi access network cell, the node determines whether to remain connected to the Wi-Fi access network cell or to move to the radio access network cell. This has the advantage that a client device that is already associated with a Wi-Fi AP can determine if another access network cell could provide it with a better service, for example if the conditions of the AP change dynamically.

As an option, the radio access network cell is any of a 3GPP radio access cell and a further Wi-Fi access network cell.

As a further option, the client device is a User Equipment.

The node described is optionally any of a Wi-Fi Access Point and a Wi-Fi Access Controller.

Various properties of the Wi-Fi access network cell and the corresponding property of the radio access network cell can be determined. Optional examples of such properties are signal strength (this may be estimated), network load, network capabilities, network congestion, available bandwidth, estimated bandwidth, and conditions of a corresponding backhaul network.

As an option, the response further includes information relating to the corresponding property of the Wi-Fi access network cell.

According to a second aspect, there is provided a client device for use in a communications network. The client device is provided with a transmitter for sending a request message towards a node in a Wi-Fi access network cell to which the client device is connected. A receiver is provided for receiving a response from the node, the response including information identifying at least one overlapping radio access network cell and a property of the overlapping radio access network cell. A processor is also provided that is arranged to, on the basis of a comparison between the property of the radio access network cell and a corresponding property of the Wi-Fi access network cell, determine whether to remain connected to the Wi-Fi access network cell or to move to the radio access network cell.

As an option, the client device is a User Equipment.

As a further option, the radio access network cell is any of a 3GPP radio access cell and a further Wi-Fi access network cell.

The transmitter is optionally arranged to send the request message towards any of a Wi-Fi Access Point and a Wi-Fi Access Controller.

As an option, the processor is arranged to compare properties, examples of which are signal strength (this may be estimated), network load, network capabilities, network congestion, available bandwidth, estimated bandwidth, and conditions of a corresponding backhaul network.

The receiver is optionally arranged to receive a response that further includes information relating to the corresponding property of the Wi-Fi access network cell. According to a third aspect, there is provided a node for use in a Wi-Fi access network. The node is provided with a receiver for receiving from a client device associated with the a Wi-Fi access network cell a request message, the request message requesting information about a property of at least one overlapping radio access network cell. A processor is also provided for determining a value for the requested property of the overlapping radio access network cell. A transmitter is provided for sending to the client device a response, the response including the value for the requested property of the overlapping radio access network cell. This has the advantage of allowing the client device to determine whether to remain associated with the Wi-Fi access network cell or move to another radio access network cell that can provide better service.

As an option, the node is also provided with a second transmitter for sending to a node in the overlapping radio access network cell a request for information about the property of the overlapping radio access network cell, and a second receiver for receiving from the node in the overlapping radio access network cell a response, the response including the requested information. As a further option, the transmitter is arranged to send the request for information to a node in the overlapping radio access network cell, the overlapping radio access network cell selected from any of 3GPP radio access cell and a further Wi-Fi access network cell.

The node is optionally any of a Wi-Fi Access Point and a Wi-Fi Access Controller.

The processor is arranged to determine a property of the overlapping radio access network cell, wherein optionally examples of the property include signal strength, network load, network capabilities, network congestion, available bandwidth, estimated bandwidth, and conditions of a corresponding backhaul network.

According to a fourth aspect, there is provided a computer program comprising computer readable code which, when run on a client device causes the client device to perform the method as described above in the first aspect.

According to a fifth aspect, there is provided a computer program comprising computer readable code which, when run on a node, causes the node to behave as the node as described above in the third aspect.

According to a sixth aspect, there is provided a computer program product comprising a non-transitory computer readable medium and a computer program as described above in either of the fourth or fifth aspects, wherein the computer program is stored on the computer readable medium.

According to a seventh aspect, there is provided a method as described above in the first aspect, when operated on a vessel or vehicle.

According to an eighth aspect, there is provided a vessel or vehicle comprising any of a client device as described above in the second aspect and a node as described above in the third aspect.

### BRIEF DESCRIPTION OF DRAWINGS

FIG. 1 illustrates schematically in a block diagram an exemplary network architecture;

FIG. 2 is a signalling diagram showing an exemplary ANQP procedure;

FIG. 3 is a signalling diagram showing exemplary signalling;

FIG. 4 illustrates schematically in a block diagram an exemplary mobile client device;

FIG. 5 illustrates schematically in a block diagram an exemplary Wi-Fi node; and

FIG. 6 illustrates schematically in a block diagram an exemplary vessel or vehicle.

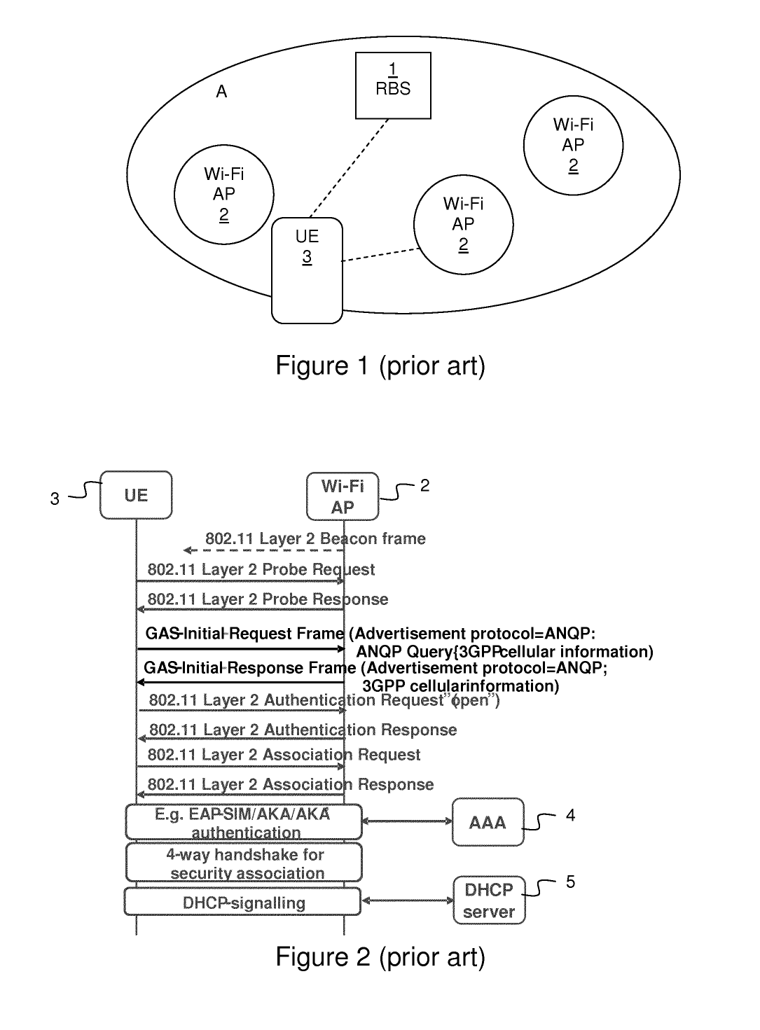

### DETAILED DESCRIPTION

The following description uses the term “Wi-Fi access network cell”. This term is used to refer to a coverage region or area that is served by one Wi-Fi Access Point (AP). It will be appreciated that Wi-Fi access network cells may overlap, in which case an AP for one of the Wi-Fi access network cells may be more suitable for use (for example, because the AP can provide a better signal strength, more bandwidth, higher capacity etc.) than another Wi-Fi access network cell. It is also possible that a single Wi-Fi AP serves simultaneously multiple Wi-Fi access network cells, for example on different frequency bands.

The description below also gives an example in which the further radio access network is a 3GPP radio access network, and that the mobile client device is a UE 3. It will be appreciated that the mobile client device may be any kind of terminal or client device that is capable of accessing the Wi-Fi access network and the further radio access network. It will be appreciated that the further radio access network may be a different type of access network, such as a second Wi-Fi access network.

It is possible for a UE to use ANQP queries to retrieve information about 3GPP cell load from a Wi-Fi AP before associating to the Wi-Fi AP. However, this technique cannot be used if the UE is already associated with the Wi-Fi AP, and so cannot account for a change in load on the Wi-Fi AP after association. The techniques described below allow a UE to decide whether to remain with the Wi-Fi AP access network cell or associate with another access network cell (e.g. 3GPP or an overlapping Wi-Fi access network cell), which is useful as the load situation on a given AP is likely to change dynamically.

When a mobile client device such as a UE 3 is connected to a Wi-Fi access network cell, it sends a query to the AP 2 with which it is associated. The AP 2 responds with information relating to properties of an overlapping radio access network cell (such as a 3GPP cell or another Wi-Fi access network cell), which allows the UE 3 to decide whether to remain associated with the current Wi-Fi access network cell or to move to the overlapping radio access network cell which can provide a better service.

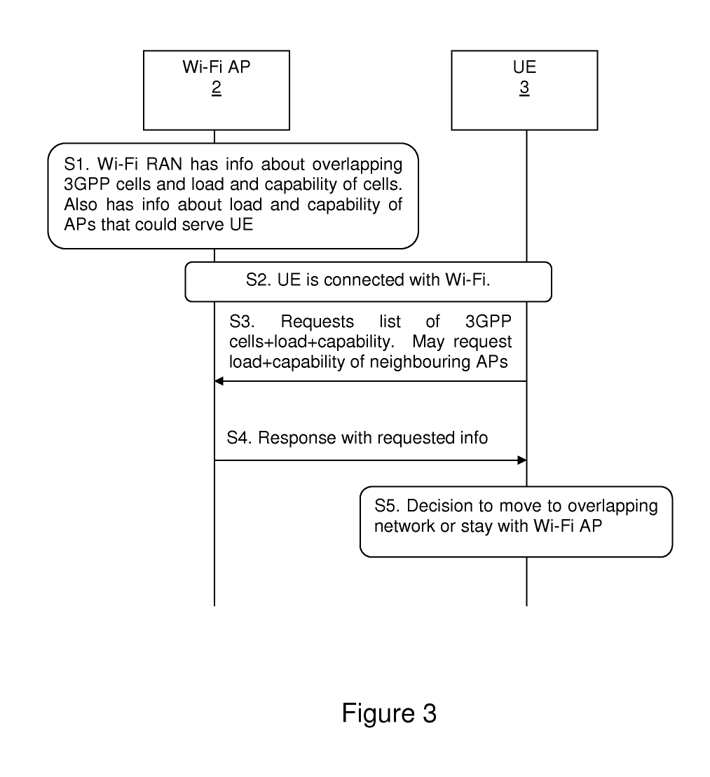

FIG. 3 shows exemplary signalling where the overlapping radio access network cell is a 3GPP cell, but it will be appreciated that it may be another type of access network such as a further Wi-Fi access network cell. The following numbering corresponds to that of FIG. 3:

S1. Wi-Fi AP 2 has information about 3GPP cells that have overlapping coverage areas with the Wi-Fi AP 2. The load and capability of the overlapping 3GPP cells are also available. This information can be later used by the UE 3 to determine whether moving to an overlapping 3GPP cell will lead to a better performance or not. Similar information is also available for APs in the vicinity of the AP 2 to which the UE 3 is connected.
S2. The UE 3 is connected to the Wi-Fi AP 2.
S3. The UE 3 sends a request to the Wi-Fi AP 2, requesting the 3GPP cell information (PLMN, RAT, cell ID, load and capability). The UE 3 may specify which PLMNs and RATs are of interest. Additionally it can request also load and capability of neighbouring APs. Furthermore, it may request information such as signal strength (or an estimated signal strength), network load, network capabilities, network congestion, available bandwidth, estimated bandwidth and conditions of a corresponding backhaul network. It will be appreciated that the list is non-exhaustive, and the UE 3 may request any pertinent information that may affect the quality of the connection to a radio access network cell.
S4. Wi-Fi AP 2 responds with a list of 3GPP cells, and the requested information (e.g. load and capability). Additionally, corresponding information for the Wi-Fi AP 2 or any further overlapping Wi-Fi access network cells (such as load and capability) may be provided.
S5. On the basis of the received information, UE 3 decides whether if it should move to one of the overlapping radio access network cells (such as a 3GPP cell or a further Wi-Fi access network cell) or stay connected to the current Wi-Fi access network cell.

In an alternative embodiment in which the UE 3 may wish to move from Wi-Fi AP 2 to a further Wi-Fi access network cell, in prior art systems the UE 3 queries the other APs itself. In this example, the Wi-Fi AP 2 scans and detects nearby Wi-Fi APs. It is possible, during this process, for the Wi-Fi AP 2 to request information such as load and capability of those nearby APs after the UE 3 has requested information about the properties (such as load, capabilities etc., as described above).

Alternatively, the Wi-Fi AP 2 may receive information about the properties of neighbouring APs from a Wi-Fi AC, which the Wi-Fi AP 2 can forward on to the UE 3. In this example, the Wi-Fi AC may send a query to nearby APs in order to gather the information about the properties of the nearby APs. Another possibility is that the Wi-Fi AC already holds the needed information based on local measurements on traffic of reports received from the Wi-Fi APs.

When the UE retrieves information about the load and capabilities of the nearby Wi-Fi APs, an exemplary way for the communication described above is to use 802.11 messages. Alternatively, the required information can be included as information elements in an existing 802.11 message, such as 802.11k messages. Another further exemplary option is to also enable the usage of ANQP messages (which are normally used when a UE 3 is attempting to associate with a Wi-Fi AP 2) even in the case as described above where the UE 3 is already associated to the Wi-Fi AP 2.

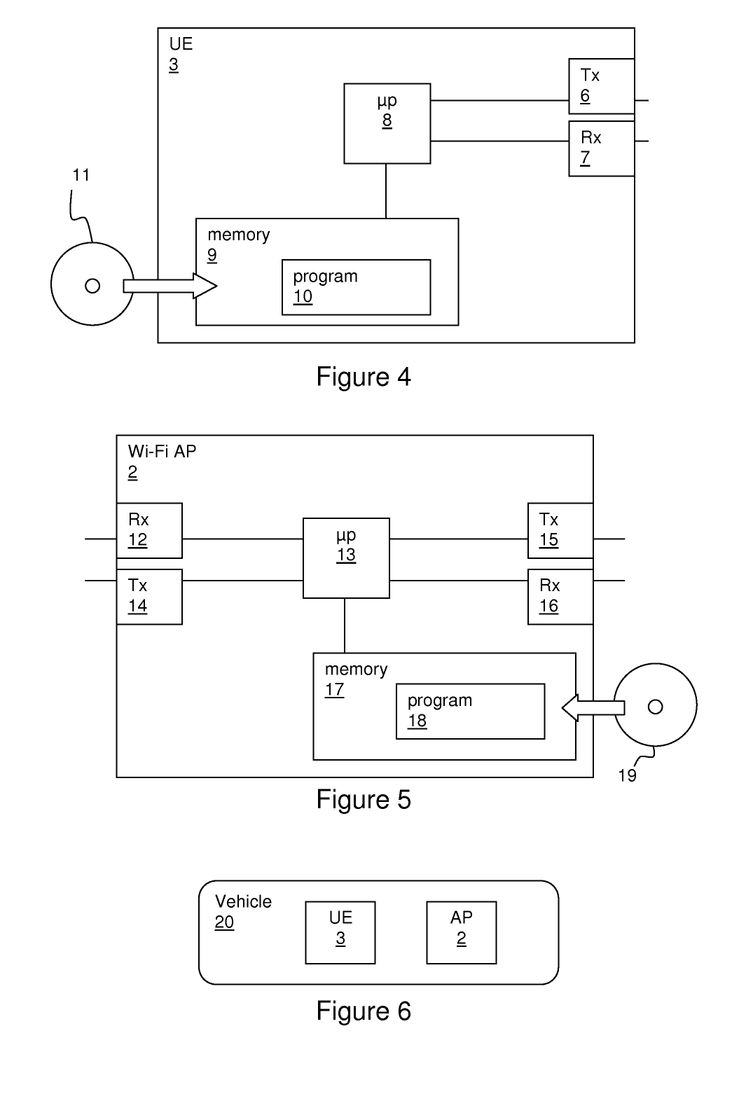

Turning now to FIG. 4, there is illustrated schematically a mobile client device such as a UE 3. The UE 3 is provided with a transmitter 6 for sending a request message towards the Wi-Fi AP 2 with which the UE 3 is already associated. The request message, as described above, requests information about properties of alternative access network cells, such as overlapping 3GPP cells or overlapping Wi-Fi access network cells served by a different Wi-Fi AP.

A receiver 7 is provided for receiving a response from the Wi-Fi AP 2. The response includes information identifying at least one overlapping radio access network cell and a property of the overlapping radio access network cell. As described above, the sort of properties that may be provided in the response include network load, network capabilities, network congestion, available bandwidth, estimated bandwidth and conditions of a corresponding backhaul network. Note that the response may also include information regarding the corresponding properties of the Wi-Fi access network cell with which the UE 3 is already associated.

A processor 8 is provided that is arranged to compare the properties of at least one of the overlapping radio access network cell and the Wi-Fi access network cell with which the UE 3 is already associated. On the basis of this comparison, the processor can determine whether the UE 3 should to remain associated with the current Wi-Fi access network cell or to move to the radio access network cell. For example, if a nearby radio access network cell can provide more bandwidth, or is experiencing less congestion, than the Wi-Fi AP 2 with which the UE 3 is associated, then the UE 3 can choose to associate with the nearby radio access cell rather than the existing Wi-Fi AP 2. The UE 3 can compare any relevant properties, including capabilities, in order to select the best radio access network cell to associate with.

These features allow the UE 3 to determine whether it is better to remain connected to the existing Wi-Fi AP 2 or to move to another radio access network cell.

The UE 3 may be further provided with a computer readable medium in the form of a memory 9 which may be used to store a computer program 10. When the computer program 10 is executed by the processor 8, it causes the UE 3 to behave as described above. A further computer readable medium in the form of a data carrier 11, such as a compact disk, flash drive, or other external data storage medium, may also be used to store the program 10. The program stored on the data carrier 11 can be transferred to the memory 9 or executed directly by the processor 8.

FIG. 5 illustrates an exemplary Wi-Fi node. In this example, the Wi-Fi node is the AP 2 with which the UE 3 is associated. However, note that some of the functionality of the Wi-Fi node may be in an associated AC or split between the Wi-Fi AP 2 and the associated AC.

The Wi-Fi AP 2 is provided with a receiver 12 a request message from the UE 3 associated with the Wi-Fi AP 2. The request message requests information about a property of at least one overlapping radio access network cell. As described above, the overlapping radio access network cell may be a 3GPP cell or an alternative Wi-Fi access network cell. Note also that the request message may request properties of all overlapping radio access network cells.

A processor 13 is provided for determining a value for the requested property of the overlapping radio access network cell, and a transmitter 14 is also provided for sending a response to the UE 3. The response includes the value for the requested property of the overlapping radio access network cell, and may also include a value for a corresponding property of the Wi-Fi access network cell with which the UE 3 is associated.

In an exemplary embodiment, the Wi-Fi AP 2 (or a Wi-Fi AC) is provided with a second transmitter 15 for sending a request for information to a node in the overlapping radio access network cell (or several nodes in several overlapping radio access network cells). The information requested is a property of the overlapping radio access network cell. Properties may include any of network load, network capabilities, network congestion, available bandwidth, estimated bandwidth and conditions of a corresponding backhaul network, and information about more than one property may be requested.

A second receiver 16 is provided for receiving a response from the node in the overlapping radio access network cell. The response includes the requested information. This can then be forwarded to the UE 3 using the transmitter 14 to allow the UE 3 to decide whether to remain associated with the existing Wi-Fi AP 2 or move to another radio access network cell.

The Wi-Fi AP 2 may be further provided with a computer readable medium in the form of a memory 17 which may be used to store a computer program 18 which, when executed by the processor 13, causes the Wi-Fi AP 2 to behave as described above. A further computer readable medium in the form of a data carrier 19, such as a compact disk or flash drive, may also be used to store the program 18. The program stored on the data carrier 19 can be transferred to the memory 17 or executed directly by the processor 13.

As described above, the functionality at the Wi-Fi side may be split between the Wi-Fi AP 2 and a Wi-Fi AC. In this case, the Wi-Fi AP 2 is the node that communicates with the UE 3 and the Wi-Fi AC is responsible for querying other nodes such as 3GPP nodes or other nearby Wi-Fi APs in order to obtain the information relating to the properties.

Referring now to FIG. 6, there is illustrated a vessel or vehicle 20. Examples of vessels and vehicles include cars, trucks, trains, aircraft, ships and so on. The vessel or vehicle 20 is provided with any of a mobile client device such as a UE 3 as illustrated in FIG. 4 and a Wi-Fi node 2 as illustrated in FIG. 5.

It will be appreciated by the person of skill in the art that various modifications may be made to the above-described embodiments without departing from the scope of the present invention. For example, the above description refers to a 3GPP radio access network cell, but it will be appreciated the same techniques can be used when a mobile client device connected to a Wi-Fi AP wishes to determine whether it would be better to move to an alternative radio access network cell, such as an alternative Wi-Fi access network cell or another type of cell that uses a different RAT.

Furthermore, it should be noted that the above description is concerned with selecting a radio access network cell (such as a Wi-Fi access network cell or a 3GPP cell), but this may be done just for specific sessions; for example, a UE 3 may be connected to a 3GPP cell for certain sessions and a Wi-Fi AP for other sessions. The term “session” is used here to refer to traffic flows, PDP Context/PDP connections and so on. It may be determined that the sessions handled by the Wi-Fi AP could be better handled by an alternative Wi-Fi AP in which case the UE will connect to the alternative Wi-Fi AP for those sessions.

The following abbreviations have been used in the above description:

### 3GPP 3rd Generation Partnership Project

### AAA Authentication, Authorization and Accounting

### AC Access Controller

### AP Access Point

### ANQP Access Network Query Protocol

### DHCP Dynamic Host Configuration Protocol

### DNS Domain Name System

### eNB E-UTRAN NodeB

### E-UTRAN Evolved UTRAN

### FQDN Fully Qualified Domain Name

### HNB Home NodeB

HeNB Home eNodeB

### LTE Long Term Evolution

### PLMN Public Land Mobile Network

### RAT Radio Access Technology

### RBS Radio Base Station

### RNC Radio Network Controller

### RNTI Radio Network Temporary Identifier

### RRC Radio Resource Control

RSSI Received signal strength indication
SMS short message service

### TMSI Temporary Mobile Subscriber Identity

### UE User Equipment

### UTRAN Universal Terrestrial Radio Access Network

### WAN Wireless Access Network

### WCDMA Wideband Code Division Multiple Access

WIC Wi-Fi Controller

1. A method of selecting a radio access network cell for connecting to a communications network, the method comprising, at a client device connected to a Wi-Fi access network cell,
sending a request message to a node in the Wi-Fi access network cell;
receiving a response from the node, the response including information identifying at least one overlapping radio access network cell and a property of the overlapping radio access network cell; and
on the basis of a comparison between the property of the radio access network cell and a corresponding property of the Wi-Fi access network cell, determining whether to remain connected to the Wi-Fi access network cell or to move to the radio access network cell.

2. The method according to claim 1, wherein the radio access network cell is any of a 3GPP radio access cell and a further Wi-Fi access network cell.

3. The method according to claim 1, wherein the client device is a User Equipment.

4. The method according to claim 1, wherein the node is any of a Wi-Fi Access Point and a Wi-Fi Access Controller.

5. The method according to claim 1, wherein the property of the Wi-Fi access network cell and the corresponding property of the radio access network cell is selected from any of:
signal strength;
network load;
network capabilities;
network congestion;
available bandwidth;
estimated bandwidth; and
conditions of a corresponding backhaul network.

6. The method according to claim 1, wherein the response further includes information relating to the corresponding property of the Wi-Fi access network cell.

7. A client device for use in a communications network, the client device comprising:
a transmitter for sending a request message towards a node in a Wi-Fi access network cell to which the client device is connected;
a receiver for receiving a response from the node, the response including information identifying at least one overlapping radio access network cell and a property of the overlapping radio access network cell; and
a processor arranged to, on the basis of a comparison between the property of the radio access network cell and a corresponding property of the Wi-Fi access network cell, determine whether to remain connected to the Wi-Fi access network cell or to move to the radio access network cell.

8. The client device according to claim 7, wherein the client device is a User Equipment.

9. The client device according to claim 7, wherein the radio access network cell is any of a 3GPP radio access cell and a further Wi-Fi access network cell.

10. The client device according to claim 7, wherein the transmitter is arranged to send the request message towards any of a Wi-Fi Access Point and a Wi-Fi Access Controller.

11. The client device according to claim 7, wherein the processor is arranged to compare properties selected from any of:
signal strength;
network load;
network capabilities;
network congestion;
available bandwidth;
estimated bandwidth; and
conditions of a corresponding backhaul network.

12. The client device according to claim 7, wherein the receiver is arranged to receive a response that further includes information relating to the corresponding property of the Wi-Fi access network cell.

13. A node for use in a Wi-Fi access network, the node comprising:
a receiver for receiving from a client device associated with the a Wi-Fi access network cell a request message, the request message requesting information about a property of at least one overlapping radio access network cell;
a processor for determining a value for the requested property of the overlapping radio access network cell; and
a transmitter for sending to the client device a response, the response including the value for the requested property of the overlapping radio access network cell.

14. The node according to claim 13, further comprising:
a second transmitter for sending to a node in the overlapping radio access network cell a request for information about the property of the overlapping radio access network cell; and
a second receiver for receiving from the node in the overlapping radio access network cell a response, the response including the requested information.

15. The node according to claim 14, wherein the transmitter is arranged to send the request for information to a node in the overlapping radio access network cell, the overlapping radio access network cell selected from any of 3GPP radio access cell and a further Wi-Fi access network cell.

16. The node according to claim 13, wherein the node is any of a Wi-Fi Access Point and a Wi-Fi Access Controller.

17. The node according to claim 13, wherein processor is arranged to determine a property of the overlapping radio access network cell selected from any of:
signal strength;
network load;
network capabilities;
network congestion;
available bandwidth;
estimated bandwidth; and
conditions of a corresponding backhaul network.

18. A computer program, comprising computer readable code which, when run on a client device, causes the client device to perform the method as claimed in claim 1.

19. A computer program, comprising computer readable code which, when run on a node, causes the node to behave as the node as claimed in claim 13.

20. A computer program product comprising a non-transitory computer readable medium and a computer program according to claim 18, wherein the computer program is stored on the computer readable medium.

21. The method according to claim 1, when operated on a vessel or vehicle.

22. A vessel or vehicle (20) comprising any of a client device as claimed in claim 7, and a node.
